(19) United States
(12) Patent Application Publication
(10) Pub. No.: US 2021/0155874 A1
(43) Pub. Date: May 27, 2021

(54) COMPOSITION FOR REMOVING CONTAMINANTS

(71) Applicant: WOW KEMICAL S.R.L., Vigonza (PD) (IT)

(72) Inventor: Adriano Marin, Baone (PD) (IT)

(21) Appl. No.: 17/045,568

(22) PCT Filed: Apr. 10, 2019
(86) PCT No.: PCT/IB2019/052957

§ 371 Date: Oct. 6, 2020

(30) Foreign Application Priority Data
Apr. 13, 2018 (IT) 102018000004479

(51) Int. Cl. C11D 3/20; C11D 3/33; C11D 3/43; C11D 1/14; C11D 1/29; C11D 1/88; C11D 1/22; C11D 11/00

(52) U.S. Cl. CPC C11D 3/2086; C11D 3/33; C11D 3/43; C11D 11/0041; C11D 1/29; C11D 1/886; C11D 1/22; C11D 1/143

(57) ABSTRACT

The present invention relates to a method for removing a contaminant based on fats, crude oil or derivatives and mixtures thereof and to a cleaning composition for use in said method.

The present invention relates to a method for removing a contaminant based on chemical agents deriving from processing, oxides, grease encrustations, crude oil or derivatives and mixtures thereof and to a cleaning composition for use in said method.

The extraction, refinement and processing of crude oil and natural gas necessarily imply the contamination of the equipment used with process residues. Said contaminants vary based on the process for which the equipment is used and can contain, in addition to other substances, aliphatic, cycloaliphatic and aromatic, linear and branched, saturated and unsaturated hydrocarbons (such as, by way of example, crude oil, asphalt, bitumen, naphtha, wax, paraffin, etc.), sulfurated compounds and mixtures thereof.

Generally, said contaminants consist of, or comprise, processing or extraction residues, which tend to adhere to the walls or to the bottom of equipment and are very difficult to remove.

The accumulation of said residues, such as paraffin wax, bitumen, carbonates and oxides, can lead to the loss of efficiency of equipment and can require prolonged downtime of plants in order to perform cleaning operations that can be demanding, expensive and, often, that do not lead to the complete removal of the residues. In this way, as well as the disadvantages in economic and process efficiency terms, the initial conditions of the plant are never restored, which can imply excessive wear and the need to replace the plants after relatively short use cycles.

In relation to pipes, such as oil pipelines, the cleaning operations are generally performed through specific devices (called “pigs”), which run inside the pipes by means of fluids, such as nitrogen gas, and can scrape the residues from the inner walls of the pipes. This operation requires the downtime of the line and requires specific equipment for every pipe and, furthermore, implies risks of fire and explosion, as the rubbing of the scraping parts of the “pig” against the metal walls of the pipe can cause sparks that can lead to the ignition of the residues of hydrocarbons and gases still inside the pipe.

Furthermore, the cleaning procedures generally imply the use of large volumes of water and chemical detergents which may be aggressive and have a strongly negative impact on the environment.

Another important problem connected with the extraction, transport, refinement and processing of crude oil is represented by spills, generally accidental, of crude oil or components and derivatives thereof into the environment.

In recent decades, because of accidents on industrial plants and off-shore extraction platforms, leaks from tankers and following natural or military events, there have been spills of substantial quantities of crude oil and derivatives that have led to the contamination of large areas, especially, but without limitations, in marine and coastal areas.

The currently available means for contrasting crude oil and similar products, to prevent dispersion in the environment and recover as much as possible also in a partially reusable form are unsatisfactory. Furthermore, the need is therefore perceived to have means for decontaminating the environment and living organisms that are efficient, cheap, eco-sustainable and with minimal environmental impact.

An object of the present invention is that of providing a method for removing contaminants derived from crude oil, or derivatives thereof, from equipment and/or the environment, that is substantially free from the disadvantages of the methods illustrated above.

The subject matter of the present invention is a method for the partial or total removal of crude oil or fractions thereof, hydrocarbons, fats in general, fatty acids and derivatives or mixtures thereof from a contaminated substrate, wherein said method comprises the application at least to the part of said substrate to be decontaminated of an aqueous composition (C) comprising:

i. at least one from citric acid, oxalic acid, tartaric acid, malic acid, the respective sodium or potassium salts, ethylenediaminetetraacetic acid (EDTA), preferably in the form of a bisodium salt, other natural or synthetic complexing agents, and mixtures thereof;

ii. at least one solvent selected from methanol, ethanol, propanol and isomers thereof, preferably propylene glycol, butanol and isomers thereof, a water soluble low molecular weight ester, preferably methyl acetate, ethyl acetate, ethyl formate, dimethyl carbonate, esters of carbonic acid, and mixtures thereof;

iii. at least one surfactant selected from soy lecithin, soy lysolecithin, coco-glucoside, alkyl polyglucoside, glyceryl oleate, a linear sodium alkylbenzene sulfonate, sodium lauryl sulfate, sodium lauryl ether sulfate and relative mixtures and

iv. an apolar solvent, such as limonene or another terpene analog thereof, preferably citral or another terpene of natural origin, tetracloroethylene, carbon tetrachloride, other halogenated solvents, and any mixtures thereof;

so as to obtain an aqueous mixture comprising the components of (C) and the residues of the contaminant.

The subject matter of the present invention is also a cleaning composition in liquid form comprising at least water and:

i. at least one selected from citric acid, oxalic acid, tartaric acid, malic acid and the respective sodium or potassium salts, ethylenediaminetetraacetic acid (EDTA) preferably in the form of a bisodium salt, other natural or synthetic complexing agents and mixtures thereof in amounts from 12 to 45%, more preferably from 20 to 45%, by weight with respect to the total weight of the composition;

ii. at least one solvent selected from methanol, ethanol, propanol and isomers thereof, preferably propylene glycol, butanol and isomers thereof, a water soluble low molecular weight ester, preferably methyl acetate, ethyl acetate, ethyl formate, dimethyl carbonate, esters of carbonic acid and mixtures thereof, in an amount from 0.5 to 10%, preferably from 2 to 5%, by weight with respect to the total weight of the composition;

iii. at least one surfactant selected from soy lecithin, soy lysolecithin, coco-glucoside, alkyl polyglucoside, glyceryl oleate, a linear sodium alkylbenzene sulfonate, sodium lauryl sulfate, sodium lauryl ether sulfate and relative mixtures from 1 to 7%, preferably from 2 to 5%, by weight with respect to the total weight of the composition; and

iv. an apolar solvent, preferably limonene or another terpene analog thereof, preferably citral or another terpene analog of limonene of natural origin, tetracloroethylene, carbon tetrachloride, other halogenated solvents, and any mixtures thereof, in an amount from 0.3 to 10%, preferably from 2 to 5%, by weight with respect to the total weight of the composition.

The following figures illustrate the advantages of the invention.

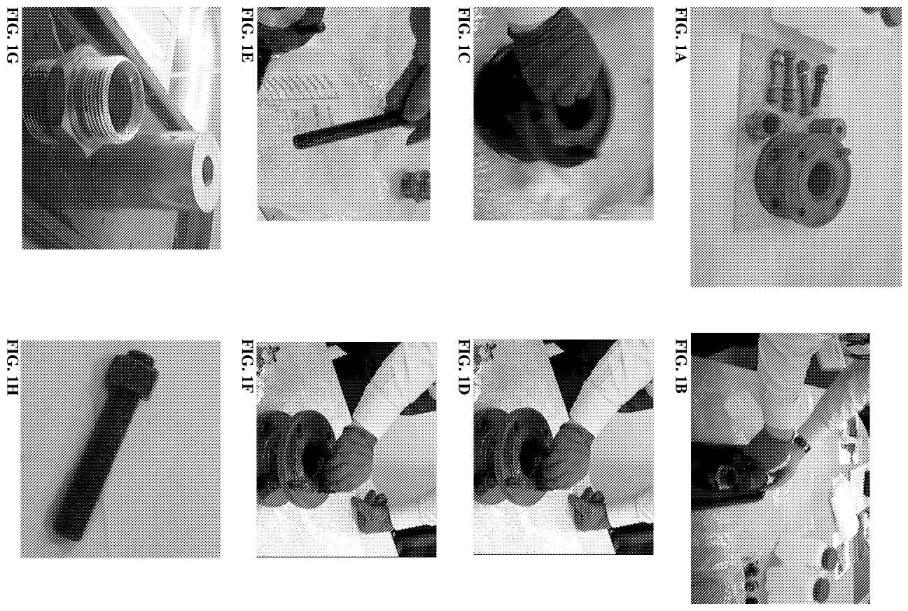

FIG. 1: Sequence of photographs showing the treatment of equipment made of zinc-plated steel (flanges, bolts, screws, nuts) contaminated with crude oil by means of the composition of the present invention.

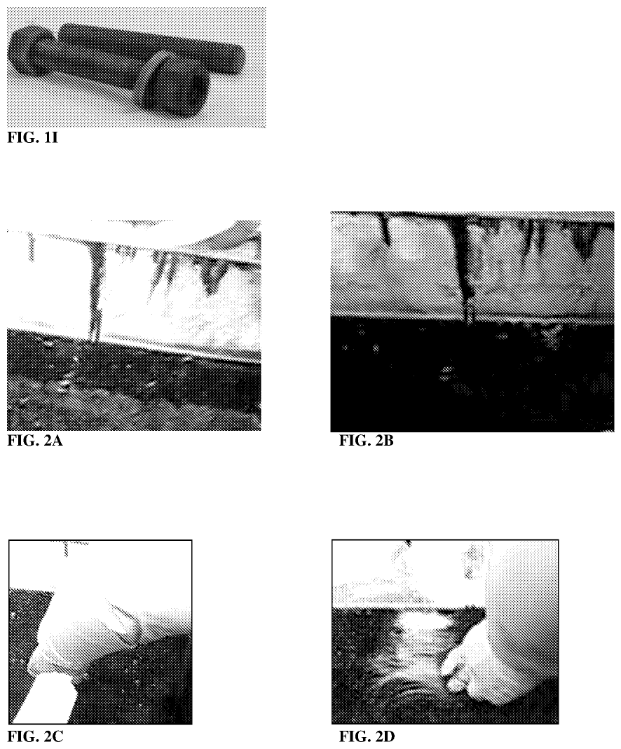

FIG. 2: Sequence of photographs showing the treatment of the wall of a tank contaminated with crude oil by means of the composition of the present invention.

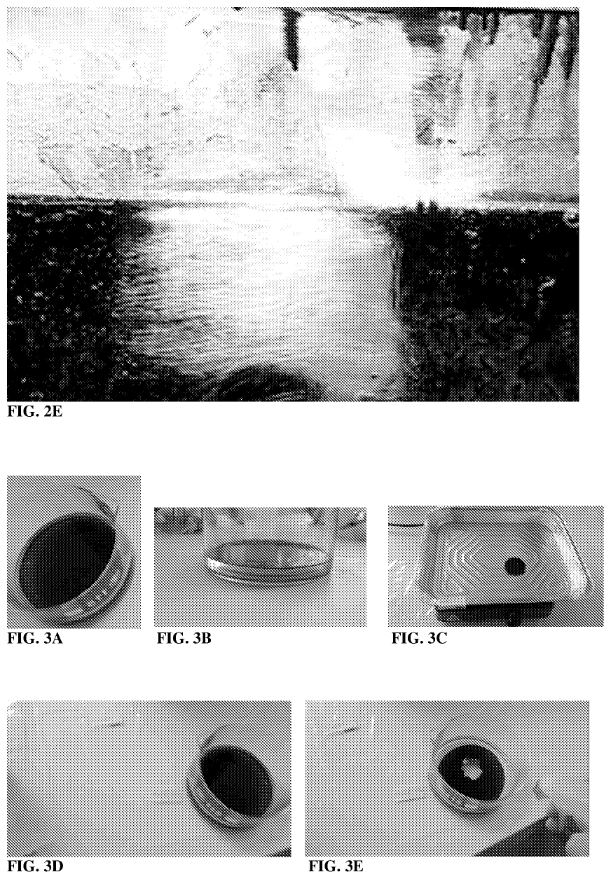

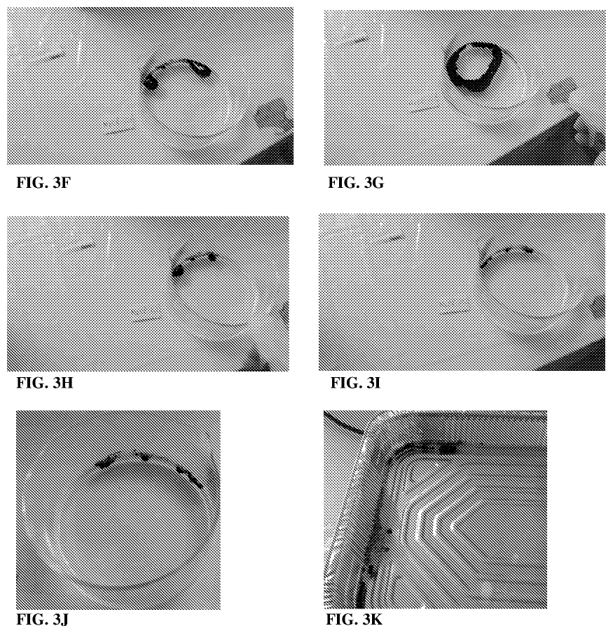

FIG. 3: Sequence of photographs showing the treatment of a two-phase system comprising crude oil (upper black phase) and an aqueous solution of NaCl (3.5% by weight) by means of spraying the composition according to the invention.

Unless otherwise indicated, within the context of the present invention the percentages and quantities of a component in a mixture relate to the weight of such component with respect to the total weight of the mixture.

Unless otherwise specified, within the context of the present invention the indication that a composition “comprises” one or more components or substances means that also other components or substances may be present in addition to the one, or ones, specifically indicated.

Unless otherwise specified, within the context of the present invention a range of values indicated for a magnitude, e.g. the content by weight of a component, includes the lower limit and the upper limit of the range. For example, if the content by weight or by volume of a component A is indicated as “from X to Y”, where X and Y are numerical values, A may be X or Y or any one of the intermediate values.

Within the context of the present invention, the citric acid can be, indifferently, in anhydrous or hydrated form, e.g. citric acid monohydrate. The amounts relate to anhydrous citric acid, unless otherwise indicated, and, in the case of using hydrated citric acid, the amounts will consequently be adapted, so as to compensate for differences in molecular mass.

The inventor has surprisingly found that it is possible to remove large quantities of contaminants based on crude oil and derivatives from matrices and surfaces of various kinds efficiently and quickly by the application of the composition as defined above.

The method of the present invention is particularly suitable for the total or partial removal of contaminants consisting of, or comprising, crude oil, derivatives or fractions or residues thereof deriving from its processing. However, the method of the present invention can also be applied, with excellent results in terms of efficiency and speed, to the removal of contaminants consisting of, or comprising, hydrocarbons in general, wax, tar, bitumen, paraffin, exhausted oils, fats (including fatty acids or derivatives thereof such as amides, esters, tri-, di- and mono-glycerides), oils, hydrocarbon compounds, pitches and similar substances. Said contaminants may be, by way of example, in the form of marks, processing residues or derivatives from accidental spills or leaks.

Advantageously, the composition (C) as defined above allows said removal to be obtained with high efficiency and minimal environmental impact, as it contains highly biodegradable components that are considered to be low pollutants and because it acts as a binder by transforming the compound being treated into an even more water repellent compound and increases the viscosity thereof, making it easier to collect through mechanical means. This latter property is particularly advantageous to allow the collection of the crude oil, and derivatives thereof, treated by the composition also in cases of emulsion which can finally be separated by means of a simple mechanical filter, e.g. of a sieve type. The current alternative is represented by well-known dispersing agents, like Corexit® by Nalco holding, which have a toxic nature and can cause pollution of the sea bed, due to the precipitation of oily residues.

In a preferred embodiment, in the method according to the present invention the aqueous composition (C) comprises a quantity of at least one from citric acid, oxalic acid, tartaric acid, malic acid, and the respective sodium or potassium salts (citrates, oxalates, tartrates, malates), ethylenediaminetetraacetic acid (EDTA) preferably in the form of a bisodium salt, other natural or synthetic complexing agents, or mixtures thereof in amounts from 12 to 45%, more preferably from 20 to 35%, even more preferably from 25 to 30% by weight with respect to the total weight of the composition (C).

Within the context of the present invention, an isomer of propanol and butanol means at least one alcohol from n-propanol (1-propanol), iso-propanol (or 2-propanol), n-butanol (or 1-butanol), sec-butanol (or 2-butanol), iso-butanol (2-methyl-1-propanol), ter-butanol (2-methyl-2-propanol), propylene glycol and mixtures thereof.

In a preferred embodiment, in the method of the present invention the solvent ii. is ethanol, or a mixture of C₁-C₄ alcohols as defined above comprising at least ethanol. In a preferred embodiment, alcohol or aliphatic alcohol preferably means ethanol.

Water-soluble low molecular weight ester means an ester with molecular weight no greater than 200 with water solubility such for which one part of solvent forms a clear and one-phase solution with 30 parts of water or less.

In a preferred embodiment, ester preferably means ethyl acetate, methyl acetate, ethyl formate, dimethyl carbonate, esters of carbonic acid and mixtures thereof, more preferably ethyl acetate and/or demethyl carbonate.

In a preferred embodiment, in the method of the present invention the solvent ii. is dimethyl carbonate, or a mixture comprising at least dimethyl carbonate.

In a preferred embodiment, in the method according to the present invention the aqueous composition (C) comprises the aliphatic alcohol or ester ii. from 0.5 to 10%, preferably from 2 to 8%, more preferably from 3 to 5% by weight with respect to the total weight of the composition (C).

Within the context of the present invention, coco-glucoside means a non-ionic surfactant generally considered to be safe (GRAS). From the point of view of the chemical structure, it is an ether between C₈-C₁₆ fatty alcohols and glucose oligomers (CAS number 141464-42-8). In water it forms a viscous, turbid solution and can be used to obtain the composition (C) according to the invention also as an aqueous solution in which the percentage of active ingredient is generally comprised between 50 and 60%. It has excellent foaming properties and is advantageously biodegradable in a relatively short time and without leaving residues, according to the criteria of EC regulation No. 648/2004 on detergents. Within the context of the present invention, “soy lecithin” means a phosphatidylcholine, i.e. a phosphoglyceride in which phosphatidic acid is esterified with choline, which can be obtained, without limitation, from soybeans or from their oil.

Within the context of the present invention “lysolecithin”, also known as hydrolyzed lecithin or isocitin, (CAS Number 85711-58-6), means a derivative of lecithin in which at least one fatty acid radical has been removed enzymatically at least in a part or in all of the phospholipids.

Within the context of the present invention, the definition “terpene analog of limonene”, includes, without limitations, compounds of natural original, terpenoids or having a monoterpene, diterpene, sesquiterpene structure, which are derivatives, precursors, diastereoisomers, optical isomers of limonene or that comprise in the chemical formula the structure of limonene. Non-limiting examples of said terpenes are cyclic terpene compounds such as terpinene, terpineol, camphor, borneol, menthol, carvone, eucalyptol, bisabolene, bergamotene, carene, carane, pinene, thujene, sabinene, germacrene, valencene, caryophyllene, lemon oil and derivatives thereof, linear terpinene compounds such as: geraniol, citral, myrcene, nerol, neral, citronellol, citronellal, linalool, linalyl acetate, ocimene, farnesol and derivatives thereof, aromatic terpene compounds such as: tujone, eugenol, anethole, thymol, safrole, chavicol and derivatives thereof and their isomers, and mixtures thereof. The composition (C) according to the present invention may contain terpenes, or analogues thereof, in the form of mixtures such as natural citrus extracts or of other plants or matrices of organic origin.

In a preferred embodiment, in the method of the present invention the terpene analog of limonene is at least one from among citral, geraniol, menthol, eucalyptol, lemon oil and citronellol. Within the context of the present invention, the definition “natural or synthetic complexing agents” means compounds able to form, reversibly or irreversibly, complexes with heavy metals and/or other contaminants. Non-limiting examples of said complexing agents are, in addition to EDTA and salts thereof, DTPA (diethylenetriamine pentaacetic acid), nitrilotriacetic acid, phosphonates, glycine, polysaccharides, polypeptides, glutamic acid, histidine, polynucleic acids, macrolides, crown ethers, ionophores and mixtures thereof.

In a preferred embodiment of the present invention, the surfactant iii. in the composition (C) is lecithin or lysolecithin, or mixtures thereof.

In a preferred embodiment, in the method according to the present invention, the aqueous composition (C) comprises the surfactant iii. in an amount from 2 to 7%, preferably from 3 to 6%, more preferably from 4 to 5% by weight with respect to the total weight of the composition (C).

In a preferred embodiment, in the method of the present invention the apolar solvent iv. is limonene, citral or another terpene analog thereof (preferably of natural origin), tetrachloroethylene, carbon tetrachloride, other halogenated solvents, and possible mixtures thereof, in amounts from 0.3% to 10%, preferably from 0.5% or 2% to 5%, by weight with respect to the total weight of the composition. In a preferred embodiment, apolar solvent preferably means limonene, citral or a mixture thereof.

In a preferred embodiment, in the method according to the present invention, the aqueous composition (C) comprises the apolar solvent iv. in an amount from 0.5 to 7.5%, preferably from 2 to 5%, by weight with respect to the total weight of the composition.

In a preferred embodiment, the composition of the present invention comprises limonene, citral or another terpene analog thereof, preferably of natural origin, or a mixture thereof, mixed with lecithin or lysolecithin, more preferably obtained from soybeans.

In a preferred embodiment, but without limitations, the three components i., ii. and iii. are in a weight ratio to each other from 6:1:1 to 20:5:6.

In a preferred embodiment of the present invention, in the composition (C) the acid i. is citric acid, the aliphatic alcohol ii. is ethanol or dimethyl carbonate and the surfactant iii. is lecithin and the apolar solvent iv. is limonene, citral or a mixture thereof.

The composition (C) in the method according to the present invention may be in the liquid or semi-liquid form e.g. without limitations, in the form of an aqueous solution, suspension, gel, cream, paste and the like.

The composition (C) in the method according to the present invention may be applied to the surface to be decontaminated through any method known to a person skilled in the art, e.g. with high or low pressure systems, by spraying, sprinkling, through brushes or other tools, or the substrate to be decontaminated can be immersed in the composition (C) and possibly treated in a galvanic cell or with an electropolisher with alternating voltage. As a convenient application, the liquid can be applied in an electrolytic cell or with an electropolisher pad/gripper. In a preferred embodiment of the present invention, the substrate to be decontaminated is at least a part of equipment used in the industrial, chemical, petroliferous or petrochemical industry, or a solid, liquid or semi-liquid substrate comprising or coated by, at least partially, hydrocarbons, fats, paraffins or mixtures thereof.

As a non-limiting example, the method of the present invention can be used for removing chemical agents deriving from processing, oxides, encrustations, mineral oils, residues and/or derivatives thereof, equipment used for the extraction, transport, processing, refinement and/or transformation of crude oil or natural gas, including, without limitations, tanks, exchangers, reactors, pipes, machinery, distillation plants and the like.

As a non-limiting example, the substrate to be decontaminated with the method according to the present invention may comprise, or consist of, metal or plastic surfaces of various kinds, surfaces coated in enamels or paints, cement and various composites. In the case of a non-electrically conducting substrate, the electropolisher pad/gripper will be provided with 2 electrodes with opposite polarities.

Furthermore, the substrate to be decontaminated with the method according to the present invention may be, without limitations, a stretch of sea, lake or water course, or another natural or artificial environment, such as a portion of land, a building or a residential area, which can be contaminated due to a natural or war event or because of an accident.

It has been surprisingly found that the application of the composition (C) according to the invention allows marks and residues containing hydrocarbons deriving from crude oil, and similar substances, to be removed efficiently and quickly. In practice, the substrate to be treated is freed almost instantaneously from the contaminants, which are transferred, as a suspension and/or solution, into the aqueous composition. The speed of the treatment is particularly advantageous for limiting the time of operations and minimizing the downtime of the plant to be decontaminated as it acts as a binder by transforming the compound being treated into an even more water-repellent compound and with greater viscosity. The current alternative is represented by well-known dispersing agents that have a toxic nature.

The method according to the present invention can comprise the separation of the aqueous mixture comprising the components of (C) and the residues of the contaminant from said substrate though any one of the methods known to a person skilled in the art (such as skimmers, oil scrapers and the like).

The subject matter of the present invention is an embodiment of a cleaning composition (C) in liquid form comprising at least water and:

i. at least one selected from citric acid, oxalic acid, tartaric acid, malic acid and the respective sodium or potassium salts, ethylenediaminetetraacetic acid (EDTA) preferably in the form of a bisodium salt, other natural or synthetic complexing agents and mixtures thereof in amounts from 12 to 45%, preferably from 20 to 35%, more preferably from 25 to 30%, by weight with respect to the total weight of the composition;

ii. at least one solvent selected from methanol, ethanol, propanol and isomers thereof, preferably propylene glycol, butanol and isomers thereof, a water soluble low molecular weight ester, preferably methyl acetate, ethyl acetate, ethyl formate, dimethyl carbonate, esters of carbonic acid and mixtures thereof, in an amount from 0.5 to 10%, preferably from 0.5% to 8%, more preferably from 2 to 5%, by weight with respect to the total weight of the composition;

iii. at least one surfactant selected from soy lecithin, soy lysolecithin, coco-glucoside, alkyl polyglucoside, glyceryl oleate, a linear sodium alkylbenzene sulfonate, sodium lauryl sulfate, sodium lauryl ether sulfate and relative mixtures from 1 to 7%, preferably from 2 to 6%, by weight with respect to the total weight of the composition, and

iv. an apolar solvent, preferably limonene or another terpene analog thereof, preferably citral or another terpene analog of limonene of natural origin, tetracloroethylene, carbon tetrachloride, other halogenated solvents, and any mixtures thereof, in an amount from 0.3 to 10%, preferably from 2 to 5%, by weight with respect to the total weight of the composition.

In a preferred embodiment of the present invention, in said cleaning composition, the acid i. is citric acid and/or the aliphatic alcohol ii. is ethanol and/or the surfactant iii. is lecithin, preferably wherein the acid i. is citric acid, the aliphatic acid ii. is ethanol and the surfactant iii. is lecithin.

In a preferred embodiment of the present invention, in said cleaning composition the acid i. is in amounts from 20 to 45% and/or the aliphatic alcohol ii. is in amounts from 2 to 5% and/or the surfactant iii. is from 2 to 6% by weight.

The composition according to the present invention can comprise further components in addition to the acid i., the alcohol ii., the surfactant iii. and the apolar solvent iv.

As non-limiting examples, said components can include salts, other surfactants, emulsifiers, preservatives, natural extracts and mixtures thereof.

In a preferred embodiment, the composition according to the present invention further comprises at least one from sodium chloride, oxygenated water, sodium acetate, trisodium citrate, sodium perborate, sodium percarbonate, acetic acid (also in the form of vinegar), orthophosphoric acid, xanthan gum, a carbonate and/or bicarbonate of an alkali metal (such as sodium carbonate and sodium bicarbonate), limonene or another terpene analog thereof (preferably of natural origin).

The limonene in the composition of the present invention may be, without limitations, racemic limonene (CAS number 138-86-3) or D-limonene (CAS Number 5989-54-8) or any scalemic mixture of the two limonene enantiomers. Preferably, the composition comprises a mixture of limonene, or another terpene analog thereof, and soy lecithin or soy lysolecithin.

Preferably, in the composition according to the present invention limonene, or another terpene analog thereof, where present, is contained in an amount from 0.3 to 7.5%, more preferably from 1 to 3%, by weight with respect to the total volume of the composition (C), and/or lecithin or lysolecithin is contained in an amount from 0.1 to 1% by weight with respect to the total volume of the composition (C). In a preferred embodiment, the apolar solvent iv. is limonene, citral or a mixture thereof and the solvent i. is dimethyl carbonate.

The composition according to the present invention is characterized by a good foaming effect, moderate wetting power, excellent cleaning and emulsifying power and good dissolving power. Furthermore, the composition according to the present invention can be used by operators wearing light garments and protection devices, generally does not cause the release of gases, is of almost completely biological origin and any dispersion into the environment could cause only minimal environmental consequences.

Compositions (approximative) that represent preferred, but not limiting, embodiments, of the present invention are reported below (by weight of components for a litre of composition):
for universal degreasing/paint stripping use (“PLUS” reinforced version):

Water 850 g, ethyl alcohol (90% v/v) or ethyl acetate 40 mL/L or, alternatively, a mixture with dimethyl carbonate from 5 to 20 mL/L, citric acid monohydrate 200 g/L, coco-glucoside 60 g/L, vinegar (6% acetic acid) 100 mL/L, limonene, 25 mL/L, lecithin 3 g/L.
for use as an oxide cleaner:

Water 720 g, ethyl alcohol (90% v/v) 28 mL/L, citric acid monohydrate 356 g/L, (ortho)phosphoric acid 85% 44 mL/L.
for use to remove stains (from laundry and generally) with oxidising power

Water 800 g, ethyl acetate 35 mL/L, citric acid monohydrate 180 g/L or alternatively sodium citrate in equal amounts or a mixture of the last two elements or alternatively tartaric acid or sodium tartrate in equal amounts, coco-glucoside 25 g/L, oxygenated water 30% (100 vol) from 50 mL/L to 200 mL/L, vinegar (6% acetic acid) 50 mL/L, sodium chloride 130 g/L.

The following examples are provided to illustrate some embodiments of the invention, without limiting the object thereof.

### EXAMPLE 1

The aqueous cleaning composition according to the present invention comprising citric acid (about 200 g/L), ethyl alcohol (about 40 g/L) and coco-glucoside (about 60 g/L), as well as limonene (about 25 g/L), other similar terpenes, and other additives, was applied to metal components (flange, screws, nuts and bolts made of zinc-plated steel) contaminated by crude oil residues.

The flange was cleaned manually with an abrasive sponge after the application of the composition of the invention in spray form (FIGS. 1a-1d).

The screws, nuts and bolts were immersed directly in the composition according to the invention. (FIGS. 1e-1f) The composition according to the present invention allowed the removal of all the oily residues formed during the storage of crude oil, bringing the equipment back to the fundamentally the same cleaning state as prior to its first use, from a visual assessment. (FIGS. 1g-1i).

Similar results were obtained through cleaning or galvanic treatment with the immersion of the objects in a solution containing the composition according to the present invention.

### EXAMPLE 2

A stainless steel tank contaminated by crude oil, which could not be removed with mechanical means (FIGS. 2a-2b), was treated with a composition according to the invention containing citric acid (about 200 g/L), ethyl alcohol (about 40 g/L) and coco-glucoside (about 60 g/L), as well as limonene (about 25 g/L) and other additives, through the application in spray form followed by the removal of the contaminant with an abrasive sponge after two hours (FIGS. 2c-2d). The complete removal of the crude oil based contaminant in the area treated was obtained (central part of FIG. 2e).

Alternatively, residues of crude oil stuck to fundamentally flat metal surfaces can be removed, after the application of the composition of the invention, e.g. in the form of spray, with an appropriately sized metal scraper.

### EXAMPLE 3

On a two-phase system comprising sea water (about 0.15 litres, power phase) and crude oil (about 1 millilitre, upper phase) in a glass container (FIGS. 3a-3b) or aluminium container (FIG. 3c) an aqueous system was sprayed, containing citric acid (20% by weight over the total volume of the composition), ethyl alcohol (4% by weight over the total volume of the composition) and coco-glucoside (6% by weight over the total volume of the composition) by means of a common manually activated sprayer. After 6 sprays (about 6 g in total) the whole organic (black) phase was bound and the aqueous phase below is clear (treatment sequence on the glass container shown in FIGS. 3d-3i).

The residual contaminant accumulates along the walls of the container (FIG. 3j, glass container, and FIG. 3k, aluminium container) and is made strongly hydrophobic by treatment with the composition according to the invention, then it can be removed with a common decontaminating system (e.g. a disc skimmer).

1. A method for the partial or total removal of a contaminant comprising crude oil or fractions thereof, hydrocarbons, fatty acids and derivatives or mixtures thereof from a contaminated substrate, wherein said method comprises the application to the part of said substrate to be decontaminated of an aqueous composition (C) comprising:
i. at least one of citric acid, oxalic acid, tartaric acid, malic acid, the respective sodium or potassium salts, ethylenediaminetetraacetic acid (EDTA), a bisodium salt, other natural or synthetic complexing agents, and mixtures thereof;
ii. at least one solvent selected from methanol, ethanol, propanol and isomers thereof, propylene glycol, butanol and isomers thereof, a water soluble low molecular weight ester, methyl acetate, ethyl acetate, ethyl formate, dimethyl carbonate, esters of carbonic acid, and mixtures thereof;
iii. at least one surfactant selected from soy lecithin, soy lysolecithin, coco-glucoside, alkyl polyglucoside, glyceryl oleate, a linear sodium alkylbenzene sulfonate, sodium lauryl sulfate, sodium lauryl ether sulfate and relative mixtures; and
iv. an apolar solvent, selected from limonene or another terpene analog thereof, citral or another terpene analog thereof of natural origin, tetracloroethylene, carbon tetrachloride, other halogenated solvents, and any mixtures thereof,
so as to obtain an aqueous mixture comprising the components of the aqueous composition (C) and the residues of the contaminant.

2. The method according to claim 1, wherein the aqueous composition (C) comprises an amount of at least one from citric acid, oxalic acid, tartaric acid, malic acid and the respective sodium or potassium salts, ethylenediaminetetraacetic acid (EDTA) a bisodium salt, other natural or synthetic complexing agents and/or mixtures thereof from 12 to 45% by weight with respect to the total weight of the aqueous composition (C).

3. The method according to claim 1, wherein the aqueous composition (C) comprises an amount from 0.5 to 10% by weight with respect to the total weight of the aqueous composition (C).

4. The method according to claim 1, wherein the aqueous composition (C) comprises an amount of the surfactant iii. from 2 to 7%, by weight with respect to the total weight of the aqueous composition (C), and/or wherein the aqueous composition (C) comprises a quantity of apolar solvent iv. in amounts from 1 to 10%, by weight with respect to the total weight of the composition (C).

5. The method according to claim 1, wherein the acid i. is citric acid or the solvent ii. is ethanol, dimethyl carbonate or mixtures thereof and/or the surfactant iii. is lecithin, or the apolar solvent iv. is limonene, citral or mixtures thereof, or wherein the acid i. is citric acid, the solvent ii. is ethanol and the surfactant iii. is lecithin and the apolar solvent iv. is limonene.

6. The method according to claim 1, wherein the substrate to be decontaminated is at least a part of equipment used in the industrial, petroliferous or petrochemical industry, or a solid, liquid or semi-liquid substrate comprising or coated by, at least partially, hydrocarbons, fats, paraffins or mixtures thereof.

7. A cleaning composition in liquid form comprising at least water and:
i. at least one of citric acid, oxalic acid, tartaric acid, malic acid and respective sodium or potassium salts, ethylenediaminetetraacetic acid (EDTA), a bisodium salt, other natural or synthetic complexing agents and mixtures thereof in amounts from 12 to 45%, by weight with respect to the total weight of the composition;
ii. at least one solvent selected from methanol, ethanol, propanol and isomers thereof, propylene glycol, butanol and isomers thereof, a water soluble low molecular weight ester, methyl acetate, ethyl acetate, ethyl formate, dimethyl carbonate, esters of carbonic acid, in an amount from 0.5 to 10% by weight with respect to the total weight of the composition;
iii. at least one surfactant selected from soy lecithin, soy lysolecithin, coco-glucoside, alkyl polyglucoside, glyceryl oleate, a linear sodium alkylbenzene sulfonate, sodium lauryl sulfate, sodium lauryl ether sulfate and relative mixtures from 1 to 7%, by weight with respect to the total weight of the composition; and
iv. an apolar solvent, selected from limonene or another terpene analog thereof, citral or another terpene analog of limonene of natural origin, tetracloroethylene, carbon tetrachloride, other halogenated solvents, and possible mixtures thereof, in an amount from 0.3 to 10%, by weight with respect to the total weight of the composition.

8. The cleaning composition according to claim 7, wherein the acid i. is citric acid and/or the solvent ii. is ethanol, dimethyl carbonate or mixtures thereof or the surfactant iii. is lecithin, or the apolar solvent iv. is limonene, citral or mixtures thereof, or where the acid i. is citric acid, the aliphatic alcohol ii. is ethanol and the surfactant iii. is lecithin and the apolar solvent iv. is limonene.

9. The composition according to claim 7, wherein the acid i. is in amounts from 20 to 45% or the aliphatic alcohol ii. is in amounts from 2 to 5%, or the surfactant iii. is from 2 to 6% or the apolar solvent iv. is in amounts from 2 to 5% by weight with respect to the total weight of the composition.

10. The composition according to claim 7, further comprising at least one from sodium chloride, sodium carbonate, sodium bicarbonate.
